(19) United States
(12) Patent Application Publication
(10) Pub. No.: US 2024/0331057 A1
(43) Pub. Date: Oct. 3, 2024

(54) Run-Time Generation of Reports from Multi-Tenant Database

(71) Applicant: People Center, Inc., San Francisco, CA (US)

(72) Inventors: Sachin Aralasurali Suryanarayana, Bangalore (IN); Shubham Choudhary, Bangalore (IN); Sanket Singhal, Ranchi (IN)

(21) Appl. No.: 18/744,214

(22) Filed: Jun. 14, 2024

Related U.S. Application Data
(63) Continuation of application No. 17/687,223, filed on Mar. 4, 2022, now abandoned.

(30) Foreign Application Priority Data
Dec. 1, 2021 (IN) 202121055690

(51) Int. Cl. G06Q 40/12; G06F 16/2455; G06F 16/2457; G06F 16/248

(52) U.S. Cl. CPC G06Q 40/125; G06F 16/2455; G06F 16/2457; G06F 16/248; G06Q 40/123

(57) ABSTRACT

Provided is a data management platform that can facilitate runtime reporting across multiple entities without intermingling data of the multiple entities in accordance with at least one embodiment described herein. For instance, a data management platform according to one or more embodiments of the present disclosure can generate and/or maintain a single, centralized database (e.g., a multi-tenant database) that can include a plurality of data models (e.g., data graphs) that can respectively correspond to different entities. The data management platform can further employ and/or access such data models that can be stored in such a centralized database to facilitate runtime reporting associated with at least one of the different entities without intermingling the data of the different entities.

### PRIORITY CLAIM

The present application is a continuation of U.S. patent application Ser. No. 17/687,223, filed Mar. 4, 2022, which is based on and claims priority to Indian Provisional Patent Application No. 202121055690, having a filing date of Dec. 1, 2021. Each of the applications identified above is hereby incorporated by reference in its entirety.

### FIELD

The present disclosure relates generally to database management technology. More particularly, the present disclosure relates to the runtime generation of reports in a multi-tenant database environment.

### BACKGROUND

Some existing data management systems utilize a multi-tenant database that can be generated and/or maintained by a single database host entity that is responsible for managing and applying the data of different client entities, as well as data of the database host entity, where all such data is stored in the multi-tenant database of the database host entity. A challenge associated with such a data management system is that inadvertent intermingling of the data in the multi-tenant database can occur when performing certain operations associated with the database host entity and/or the different client entities (e.g., operations completed during generation of a report from the multi-tenant database), which can cause data security and/or modeling problems.

### SUMMARY

Aspects and advantages of embodiments of the present disclosure will be set forth in part in the following description, or can be learned from the description, or can be learned through practice of the embodiments.

One example aspect of the present disclosure is directed to data management system that performs runtime generation of multi-entity reports from a multi-tenant database without intermingling of data. The data management system includes one or more processors. The data management system includes the multi-tenant database that stores a plurality of datasets that are respectively associated with a plurality of different database client entities associated with a database host entity, and wherein the multi-tenant database stores the plurality of datasets separately from one another. The data management system includes one or more non-transitory computer-readable media that store instructions that, when executed by the one or more processors, cause the data management system to perform operations. The operations include receiving request data comprising a request for one or more reports associated with two or more of the database client entities. The operations include accessing, based at least in part on the request data, data associated with the plurality of database client entities, wherein the data is stored in the multi-tenant database in which the plurality of datasets respectively associated with the plurality of database client entities are stored separately from one another. The operations include merging into a temporary reporting dataset, during one or more runtime operations, at least a portion of each of two or more of the plurality of datasets that are respectively associated with the two or more the plurality of database client entities. The operations include generating, during the one or more runtime operations, the one or more reports associated with the two or more of the database client entities based on the temporary reporting dataset. The operations include providing the one or more reports as an output.

Other aspects of the present disclosure are directed to various systems, apparatuses, non-transitory computer-readable media, user interfaces, and devices for the generation of reports at runtime.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example environment including a computing system that performs operations according to example embodiments of the present disclosure.

FIG. 2 depicts a block diagram of an example of a computing device according to example embodiments of the present disclosure.

FIG. 3 depicts a flow diagram of generating reports at runtime according to example embodiments of the present disclosure.

FIG. 4 depicts a flow diagram of generating reports at runtime according to example embodiments of the present disclosure.

FIG. 5 depicts a flow diagram of generating reports at runtime according to example embodiments of the present disclosure.

FIG. 6 depicts a flow diagram of generating reports at runtime according to example embodiments of the present disclosure.

FIG. 7 depicts a flow diagram of generating reports at runtime according to example embodiments of the present disclosure.

FIG. 8 depicts a flow diagram of generating reports at runtime according to example embodiments of the present disclosure.

FIG. 9 depicts a flow diagram of generating reports at runtime according to example embodiments of the present disclosure.

Reference numerals that are repeated across plural figures are intended to identify the same features in various implementations.

### DETAILED DESCRIPTION

The present disclosure is generally directed to the generation of one or more reports at runtime (also referred to herein as “runtime reporting” and/or “reporting runtime”). More specifically, the present disclosure is directed to a data management platform that can facilitate runtime reporting across multiple entities without intermingling data of the multiple entities in accordance with at least one embodiment described herein. For instance, a data management platform according to one or more embodiments of the present disclosure can generate and/or maintain a single, centralized database (e.g., a multi-tenant database) that can include a plurality of data models (e.g., data graphs) that can respectively correspond to different entities. In these one or more embodiments, the data management platform can further employ and/or access such data models that can be stored in such a centralized database to facilitate runtime reporting associated with at least one of the different entities without intermingling the data of the different entities.

To generate one or more reports at runtime without intermingling the data of different entities that can be stored in a centralized database (e.g., a multi-tenant database), a data management platform according to one or more embodiments of the present disclosure can generate and/or maintain multiple sets of data objects that can respectively correspond to multiple entities (e.g., a database host entity and at least one client entity of the database host entity) and/or multiple locations associated with the multiple entities. In these one or more embodiments, the multiple sets of data objects can respectively include one or more values corresponding to one or more data fields. At a reporting runtime, the data management platform according to one or more embodiments of the present disclosure can execute a hybrid class that generates a hybrid runtime data object including location-specific data that can correspond to the multiple entities and the multiple locations. In these one or more embodiments, the data management platform can evaluate a mapping file of the hybrid class with respect to a certain location to determine whether to retrieve a reporting value of a reporting data field associated with the location-specific data from a first data object corresponding to a first entity (e.g., a client entity) or from a second data object corresponding to a second entity (e.g., the database host entity). In these one or more embodiments, based at least in part on such evaluation of the mapping file, the data management platform can access the first data object or the second data object to retrieve the reporting value, thereby preventing intermingling of data respectively corresponding to the first entity and the second entity. In some embodiments of the present disclosure, the data management platform can further generate a report based at least in part on the hybrid runtime data object and/or output the report (e.g., via a graphical user interface (GUI) and/or a display of a computing system (e.g., a computer) that can be associated with the data management platform). Thus, at runtime, a computing system can select and merge portions of separate datasets that correspond to different entities (e.g., different client entities of a database host entity) so as to create a temporary runtime dataset. Reports can be generated based on the temporary runtime dataset and, subsequent to generation of the reports, the temporary runtime dataset can be deleted, e.g., so as to prevent any non-volatile intermingling of data from different entities.

In one or more embodiments of the present disclosure, the first entity can be a database host entity and the second entity can be a client entity of the database host entity. In these one or more embodiments, the multiple sets of data objects, the first data object, the second data object, and/or one or more third data objects respectively corresponding to one or more third entities can be stored in a centralized database such as, for instance, a multi-tenant database. In these one or more embodiments, the data management platform can initially generate and/or maintain (e.g., in a multi-tenant database) a single set of data objects that can correspond to the first entity (e.g., the database host entity) and the multiple locations. In these one or more embodiments, the data management platform can subsequently generate and/or maintain (e.g., in a multi-tenant database) the above-described multiple sets of data objects that can respectively correspond to the multiple entities and the multiple locations based at least in part on receipt of data indicative of the second entity (e.g., the client entity) joining the first entity.

According to one or more embodiments described herein, the multiple locations can be multiple reporting jurisdictions. In some embodiments of the present disclosure, the above-described mapping file can be an index, a list, a configuration file, and/or a look-up table that indicates, with respect to a certain location, whether the reporting data field is associated with the first entity or the second entity. In some embodiments, the reporting value that can be retrieved from the first data object or the second data object can include at least one attribute of the first entity or the second entity, respectively. For example, in one or more embodiments described herein, the reporting value can include reporting account identification data of the first entity or the second entity, where the reporting account identification data can correspond to a certain location.

According to another aspect, the systems and methods of the present disclosure can also enable modifications to entity information which occur during an ongoing period (e.g., a month, a quarter, etc.). These modifications can be referred to as mid-period modifications. One example of such a modification is the joining or unjoining of a client entity with a database host entity. In some implementations, in order to enable mid-period modification and/or generation of reports subsequent to mid-period modifications, the systems described herein can maintain multiple sets of data objects that respectively correspond to multiple entities, where the multiple entities include one or more pre-modification entities and one or more post-modification entities. Stated differently, in some implementations, when a client entity joins a database host entity, new data object(s) can be generated for the client entity and/or database host entity which reflect the modification to the data records. Data prior to the modification can be maintained in the data objects that existed prior to the modification while data subsequent to the modification can be maintained in the data objects that were generated as a result of the modification. Then when a report is generated, the multiple data objects can be used to create multiple reports which accurately reflect the pre- and post-modification status of the data. Alternatively or additionally, one or more flags or data values (e.g., date values) can be maintained in one or more data objects to indicate a start and/or end date of the relevance of the data to a certain data object and/or entity. For example, date values can be maintained which indicate when a client organization joined a host entity and such date values can be used to bifurcate or otherwise appropriately separate data that relates pre- and post-mid-period modifications.

Aspects of the present disclosure provide numerous technical effects and benefits. For example, the data management platform described herein in accordance with one or more embodiments of the present disclosure can facilitate runtime reporting across multiple entities without intermingling data (e.g., organizational data) of such entities, where such data can be configured and/or formatted as discrete data models (e.g., data graphs having data objects) that can be stored in a centralized database (e.g., a multi-tenant database). For instance, at a reporting runtime involving and/or associated with a database host entity and a client entity of the database host entity, the data management platform according to one or more embodiments of the present disclosure can prevent intermingling of data and/or data models (e.g., data graphs) respectively corresponding to the database host entity and the client entity when performing certain operations associated with the reporting runtime, the database host entity, and/or the client entity (e.g., operations completed during a reporting event). In this example, by preventing such intermingling of such data and/or data models of the database host entity and the client entity, the data management platform according to one or more embodiments of the present disclosure can reduce and/or eliminate data security and/or modeling problems that can be associated with performing a runtime reporting across multiple entities. Thus, the security and privacy of an entity's data can be improved (e.g., which can result in a reduction in fraud, data theft, etc.).

As another example, the data management platform according to one or more embodiments of the present disclosure can provide for storing of multiple data graphs respectively corresponding to different entities in a single, centralized database rather than multiple databases that must be accessed by one or more processors during the above-described reporting runtime to retrieve data from the multiple data graphs. In this example, the data management platform according to one or more embodiments of the present disclosure can thereby facilitate at least one of improved processing efficiency, improved processing capacity, improved processing performance, and/or reduced computational costs of one or more processors that can be associated with the data management platform and that can execute one or more operations (e.g., retrieval of data values from one or more data graphs) in connection with the above-described reporting runtime.

In some embodiments, the data management platform described herein in accordance with one or more embodiments of the present disclosure can be implemented to augment and/or replace existing data management platforms and/or multi-tenant databases that utilize a “hub and spokes” architecture. In these embodiments, the “hub” corresponds to core features of an entity (e.g., an organization, a company, etc.) such as, accounts, entity and client information, onboarding and/or offboarding flows, and/or another feature, while the “spokes” correspond to individual services of the entity. In these embodiments, the data management platform described herein in accordance with one or more embodiments of the present disclosure can be implemented to augment and/or replace such existing data management platforms and/or multi-tenant databases that utilize a “hub and spokes” architecture to provide a robust and/or scalable data management platform that can facilitate a reporting runtime across multiple entities associated with the data management platform without intermingling data of such entities.

As described above, example aspects of the present disclosure are directed to the generation of reports at runtime without intermingling data (e.g., organizational data) of different entities that can be stored in a centralized database such as, for instance, a multi-tenant database. Accordingly, one or more example embodiments of the present disclosure are directed to a computing system that can be used to: maintain (e.g., in a multi-tenant database) multiple sets of data objects respectively corresponding to multiple entities and multiple locations, where the multiple sets of data objects respectively include one or more values corresponding to one or more data fields; execute, at a reporting runtime, a hybrid class to generate a hybrid runtime data object including location-specific data corresponding to the multiple entities and the multiple locations; generate a report based at least in part on the hybrid runtime data object; and/or output the report. In these one or more example embodiments, to facilitate executing, at the reporting runtime, the hybrid class to generate the hybrid runtime data object, the computing system can be further used to: evaluate, with respect to at least one location, a mapping file of the hybrid class to determine whether to retrieve at least one reporting value of at least one reporting data field from a first data object corresponding to a first entity or from a second data object corresponding to a second entity; and/or to access the first data object or the second data object to retrieve the at least one reporting value based at least in part on evaluation of the mapping file. As one example, the mapping file can indicate, for each of a number of regions, whether the region is a client region or a host region.

Thus, one example aspect is directed to a computing system that performs operations to perform runtime generation of reports. The operations include receiving request data comprising a request for one or more reports associated with a host entity. The operations include accessing, based at least in part on the request data, organizational data associated with a plurality of client entities of the professional employer organization, wherein the organizational data is stored in a multi-tenant environment in which a plurality of datasets of the organizational data that are respectively associated with the plurality of client entities are stored separately from one another. The operations include merging, during one or more runtime operations, at least a portion of each of two or more of the plurality of datasets of the organizational data that are respectively associated with the plurality of client entities into a temporary reporting dataset. The operations include generating, during the one or more runtime operations, the one or more reports associated with the professional employer organization based on the temporary reporting dataset. The operations include providing the one or more reports as an output.

Example aspects of the present disclosure are further directed to a data management platform that controls and leverages organizational data to enable the automatic generation of reports for different users or groups of users (e.g., groups of employees of an organization) included in a set of users (e.g., all employees of an organization).

The data management platform can hold, for each of one or more organizations, a centralized set of organizational data that acts as a single, centralized system of record for all organizational management processes for that organization. Each organization can include a number of users which are able to access and interact with the data management platform. Some users may have administrative permissions which define whether the user is able to access and/or modify certain types of organizational data for their organization.

The organizational data for each organization can include data directly entered into the data management platform and/or can include data retrieved, pulled, or otherwise obtained from one or more first party and/or third-party applications with which the data management platform may have varying levels of integration. This ingestion and storage of data from third-party applications is in contrast to systems which simply sit on top of third-party applications and apply rules at runtime. In some implementations, the data management platform can provide a user with the ability (e.g., by configuring Simple Mail Transfer Protocol (SMTP) settings) to configure the cadence or periodicity at which the data management platform receives or ingests data (e.g., via.csv files) from third-party applications.

The organizational data can, in some implementations, be held as one or more object databases. For example, multiple object classes can be defined in the object databases. For each object, values can be provided and maintained for one or more attributes, such as location, role, salary, etc. Links can be made between different objects. For example, one or more device objects can be associated with employee objects.

The object database(s) can be represented as or can store data which can be represented as one or more graphs with nodes that correspond to objects and edges that correspond to links or logical associations between objects and/or object attribute(s). Graph(s) can be traversed to understand or leverage relationships among objects and their attribute(s). In one example, the organizational data can be synthesized into a single graph which includes multiple classes of objects and defines complex relationships among objects and their attribute(s). For example, all workflows can be run through one platform and graph.

In some implementations, the organizational data can include organizational structure data. For example, the organizational structure data can be encoded within links or edges defined between objects of the organizational data or can be stored as a separate data layer. For example, the organizational structure data can define organizational relationships between objects, including employee objects. As one example, the organizational structure data may indicate that a first employee object has the relationship of “manager” relative to a second employee object. The organizational relationships can be defined between specific objects and/or groups of objects. As another example, the organizational structure data may indicate that a first group of employees (e.g., the “IT Administrator” group of employees) has a certain set of permissions (e.g., device activation/deactivation) relative to a particular group of devices (e.g., the “work laptops” group of the devices).

According to one example aspect, an administrator or other user of the data management platform can be enabled to perform operations that generate professional organization reports based on organizational data and location-specific data. In one or more embodiments of the present disclosure, the data management platform can constitute and/or include a computing system that can be employed (e.g., by an administrator or other user of the data management platform) to perform such operations to generate the professional organization reports based on organizational data and/or location-specific data. In some embodiments, when used to validate organizational records, such a computing system can be referred to as a report generation computing system.

In some implementations, the above-described computing system and/or report generation computing system (hereinafter, “computing system” or “the computing system”) can include a graphical user interface that provides an easy way to view and modify fields and entries of reports with a relatively low level of user foreknowledge. For example, a user can modify entries by selecting fields that are provided via the graphical user interface. In this way, the potentially complicated process of manually reviewing and validating reports can be greatly facilitated.

By way of example, a computing system implementing the disclosed technology can access request data that includes a request for one or more reports associated with an entity (e.g., a host entity). The computing system can then access, based at least in part on the request data, organizational data associated with the entity. The organizational data can include information associated with a plurality of entities including the entity. Further, the organizational data can be stored in a multi-tenant environment in which a plurality of datasets of the organizational data that are respectively associated with the plurality of client entities are stored separately from one another. The computing system can access, based at least in part on the request data associated with the entity, location-specific data that includes location-specific information for the one or more regions associated with the entity. Furthermore, the computing system can generate output (e.g., a report), based at least in part on one or more runtime operations performed on the location-specific data and the organizational data associated with the entity. The output can include one or more reports associated with the entity.

Accordingly, the disclosed technology may improve the effectiveness with which reports are generated. In particular, the disclosed technology can generate reports in a manner that safeguards the privacy of entities that store organizational data in a multi-tenant environment.

The computing system can receive, access, obtain, and/or retrieve data which can include request data. The request data can include one or more requests (e.g., a request) for one or more reports that can be associated with an entity. For example, the computing system can receive request data including a request from a user (e.g., an authorized user) for a report for the current quarter (e.g., a three-month period including the current day).

The request data can include one or more names of an entity (e.g., a registered business name of an entity, a “doing business as” name of an entity) in one or more regions (e.g., one or more geographic regions) and/or an entity identifier (e.g., a unique number or set of numbers that can be used to access organizational data associated with the entity). Further, the request data can include information that can be used to access organizational data associated with the entity including a location (e.g., physical location and/or logical location) of the organizational data for the entity. For example, the request data can be used to access an entity's organizational data that is stored in a multi-tenant environment (e.g., a multi-tenant database) that includes the organizational data of other entities.

The entity can include an individual and/or an organization (e.g., a corporation). Further, the entity can be organized such that the entity is established in one or more regions. For example, the entity can have one or more names in the one or more regions (e.g., the entity can have the same name in all regions, different names in different regions, or the same name in some regions and different names in other regions).

The computing system can access data that can include organizational data that is associated with the entity. Further, accessing the organizational data can be based at least in part on the request data. For example, the computing system can use the identity of the entity that is included in the request data to access one or more portions of organizational data that are associated with the entity. The organizational data can include information associated with a plurality of entities including the entity and/or one or more regions associated with the entity. For example, the organizational data can include data for multiple organizations in different geographic regions. Further, the organizational data can be stored in a multi-tenant environment in which a plurality of datasets of the organizational data that are respectively associated with the plurality of client entities are stored separately from one another. For example, the organizational data can be stored in a single, multi-tenant database and/or in a set of multi-tenant databases that include the organizational data for different entities.

In some embodiments, the plurality of entities can include a plurality of organizations. For example, each of the plurality of entities can be an organization (e.g., a business) that operates in at least one country or sub-region (e.g., state or province) of a country. Further, the organizational data for each of the plurality of entities can be segregated from organizational data of other entities of the plurality of entities. For example, the organizational data for each entity can be stored in a discrete data model (e.g., data graph) and/or in a separate partition of a database that maintains the organizational data. Further, each data model and/or separate partition of the database can be configured to be accessible only to the entity that is associated with that data model and/or partition (e.g., access to each data model and/or partition can be based on a passcode that is provided to the respective entity).

In some embodiments, the plurality of entities can be respectively associated with a plurality of shards of the organizational data. For example, the organizational data can include a plurality of database tables and each of the plurality of entities can be horizontally partitioned so that each entity is associated with a separate database table.

By way of example, the computing system can access organizational data that is stored locally and/or on one or more remote computing systems and/or one or more remote computing devices. Further, the organizational data can be under the control of the entity (e.g., the entity has access to the organizational data and the ability to modify and/or delete one or more portions of the organizational data).

The computing system can access data including location-specific data. Accessing the location-specific data can be based at least in part on the request data and/or the organizational data associated with the entity. The location-specific data can include location-specific information and/or data for the one or more regions associated with the entity.

For example, the location-specific information can include information that is applicable to the entity as an individual organization and/or as part of a host entity. By way of further example, the request data can include information associated with the region (e.g., country, state, city, jurisdiction, etc.) for which location-specific data will be accessed. If the request includes a request for a report for the state of Illinois in the United States of America, the computing system will access the location-specific data including state location-specific data associated with the state of Illinois and/or federal location-specific data associated with the United States.

The computing system can generate output. Generation of the output can be based at least in part on one or more runtime operations performed on the location-specific data and/or the organizational data associated with the entity. The output can include one or more reports associated with the entity. The one or more reports can be configured and/or formatted in accordance with one or more templates and can be used to fulfill one or more location-specific and/or reporting requirements.

Furthermore, the one or more reports can include data and/or information associated with one or more names of employees of the organization, one or more names of contractors that perform work for the organization, one or more identifiers that can be used to uniquely identify any employee of the entity, and/or any third-party that is associated with the entity.

In some embodiments, the one or more reports can include information in which a host entity is indicated as the employer of record for the entity.

The computing system can determine whether, when, and/or if the one or more runtime operations have been completed. For example, the computing system can monitor the one or more runtime operations and determine when the last runtime operation has been completed.

Further, in response to determining that the one or more runtime operations have been completed, the computing system can delete any data generated during the one or more runtime operations. For example, the one or more runtime operations can include the generation of data and/or information that is stored on one or more storage devices and/or one or more memory devices. After determining that the one or more runtime operations have been completed, the computing system can delete the data and/or information that is stored on the one or more storage devices and/or the one or more memory devices. In this way, confidential and/or private information of the entity will not be available on the devices that were used to generate the one or more reports.

In some embodiments, the one or more runtime operations can be performed using one or more volatile memory devices. For example, the one or more runtime operations can store data and/or one or more instructions on RAM (random access memory) to which power is interrupted after completion of the one or more runtime operations, thereby resulting in loss of the stored data and/or one or more instructions.

In some embodiments, the one or more runtime operations can be performed iteratively over one or more iterations. For example, the one or more iterations can be associated with the one or more geographic areas (e.g., one iteration per geographic area) and/or one or more types of information. Further, the one or more runtime operations can include validation of the one or more reports after each of the one or more iterations. Further, the computing system can perform various error checking operations (e.g., checksums) to determine whether totals and/or intermediate quantities calculated during the one or more runtime operations are correct and/or within some margin of error.

In some embodiments, validation of the one or more reports can include validation of syntax, consistency validation, and/or quantitative validation. For example, syntax validation can include checking whether the syntax used in a report are valid and does not include invalid characters (e.g., a name with a dollar ($) sign or a salary entry that includes alphabetic characters). Further, consistency validation can include determining whether a report includes consistent references to the same entity (e.g., an entity is consistently referred to as an “LLC” and not referred to as an “LLC” in one part of a report and an “LLP” in another part of the same report). Additionally, the determination of quantitative invalidity can include a determination of whether one or more values of a report exceed a predetermined maximum amount or are less than a predetermined minimum amount. For example, a report that indicates that an entity has a trillion (1,000,000,000,000) employees may quantitatively invalid.

In some embodiments, the one or more runtime operations are only performed after the request data is accessed and before the output is generated. For example, the one or more runtime operations can begin to be performed after the request data is accessed and can end before the output (e.g., the one or more reports) is generated.

In some embodiments, generating the output can include the generation of one or more entity objects at runtime. Generation of the one or more entity objects can be based at least in part on the organizational data and/or the location-specific data. Further, the one or more entity objects can be respectively associated with the one or more regions. For example, the computing system can generate one or more data objects including one or more entity objects that are associated with the entity. Further, the one or more entity objects can be instances of one or more classes that are associated with the entity. For example, the one or more entity objects can include an entity object that is based on an organization class that includes attributes associated with names, employee numbers, and salary of employees of the organization. Each instance of the one or more entity objects can include a unique employee with an associated employee number and salary. Further, any of the one or more entity objects can include a set of one or more entity objects. For example, an entity object for a particular organizational division can include the one or more entity objects associated with only that particular organizational division.

In some embodiments, determining the one or more reports can be based at least in part on the one or more entity objects. Further, the one or more reports can be based at least in part on information and/or data from the one or more entity objects.

In some embodiments, the one or more reports can be associated with the one or more regions associated with the entity. For example, the one or more reports can include a report for the entity in three regions including a federal level report for the entity in a first region (e.g., a country), a second report for the entity in a second region (e.g., a country that is different from the country associated with the first region), and a third report for the entity in a division of the second region (e.g., a state, a city, or a jurisdiction of, for instance, the second region).

In some embodiments, the entity can include an organization and/or a division of the organization. Further, the entity can include divisions and/or sub-divisions that represent portions of the organization. For example, a division of an entity can include a particular department (e.g., marketing department), a geographic division of the entity (e.g., the French division, the Canadian division, etc.), a hierarchical division (e.g., the vice-presidents of an organization), or some user-selected division that satisfies some user criteria (e.g., the portion of an organization with a salary above a certain threshold amount).

In some embodiments, the organizational data can include the location-specific data. For example, a portion of the organizational data can include the location-specific data. Further, the location-specific data can be associated with one or more portions of the organizational data. For example, the location-specific data for a region can be stored in a portion of the organizational data for that geographical area.

The computing system can generate a graphical user interface that includes one or more interface elements associated with the one or more reports (e.g., one or more reports). Further, the one or more interface elements can be configured to receive one or more inputs. For example, the graphical user interface can be generated on a touch sensitive (e.g., capacitive touch sensing) display output component of the computing system and can be configured to receive one or more inputs (e.g., one or more touch inputs) from the user.

Further, the computing system can receive the one or more inputs. The one or more inputs can include one or more tactile inputs (e.g., the user touching the display output component with a finger) and/or one or more aural inputs (e.g., the user speaking a command). For example, the one or more inputs can include the user tapping an interface element associated with a report in order to view the report. The user can then scroll through the report by swiping their finger on the representation of the report that is displayed on the graphical user interface.

Further, the computing system can perform one or more interface operations on the one or more reports. The one or more interface operations can be based at least in part on the one or more inputs. For example, the one or more interface operations can be used to generate a request for the one or more reports or to annotate a report (e.g., make notations regarding portions of the one or more reports that may require further review).

In some embodiments, the one or more interface operations can include deleting a report, modifying a report, and/or sending a report to one or more remote computing devices. For example, based on a user input to an interface element labelled “SAVE REPORT” an authorized user can save (e.g., store) a copy of a report on a storage device (e.g., either a local storage device or a remote storage device). Further, the user can use the one or more interface elements to modify the one or more reports based at least in part on the one or more inputs. For example, the computing system can be configured to use the one or more inputs as an input that is provided to modify the one or more reports by either adding information to the report (e.g., adding an annotation) or removing information from a report (e.g., striking through or deleting some portion of a report that may be redundant).

In some embodiments, deleting a report can include deleting one or more reports or deleting one or more portions of one or more reports. For example, a user could delete selected pages of a report or an entire report. Furthermore, sending a report to one or more remote computing devices can include sending one or more reports to a personal device (e.g., a smartphone, laptop, and/or tablet) of a user.

In some embodiments, the one or more runtime operations can be performed without modifying the organizational data and/or the location-specific data. For example, the one or more runtime operations can include accessing the organizational data and/or the location-specific data without writing or deleting any of the organizational data and/or location-specific data.

In some embodiments, the plurality of datasets can be encrypted and configured to be encrypted or decrypted using one of a plurality of encryption keys respectively associated with the plurality of entities. For example, a dataset can be encrypted using an encryption algorithm (e.g., Advanced Encryption Standard (AES)) that encodes the plurality of datasets and uses a two-hundred and fifty-six bit key length to decrypt the dataset or encrypt additional data that is added to the dataset.

The disclosed technology can include a computing system and/or computing device that is configured to perform various operations associated with the generation of reports. In some embodiments, the computing system and/or device can be associated with various other computing systems and/or devices that use, send, receive, and/or generate information and/or data associated with the generation of reports. Furthermore, the computing system and/or device can process, generate, modify, and/or access (e.g., send and/or receive) data and/or information including data and/or information associated with one or more fields respectively associated with one or more entries of one or more organizational records.

In some implementations, the disclosed computing system can be operated from a server computing system that may be accessed by a user via one or more computing devices that are connected to the server computing system. Further, the disclosed computing system can be configured to access organizational data that may be stored locally or at remote locations that are accessible via a communications network (e.g., a Local Area Network (LAN) and/or the Internet).

The computing system and/or computing device can include specialized hardware and/or software that enables the performance of one or more operations specific to the disclosed technology. Further, a computing system and/or computing device can include one or more application specific integrated circuits that are configured to perform operations associated with the generation of reports.

The systems, methods, devices, apparatuses, and tangible non-transitory computer-readable media in the disclosed technology can provide a variety of technical effects and benefits including an improvement in the generation of reports. In particular, the disclosed technology may assist a user (e.g., an administrator of organizational data) in performing a technical task by means of a continued and/or guided human-machine interaction process in which the user can interact with a user interface that can be used to generate and/or configure one or more reports associated with an organization. Furthermore, the disclosed technology may also provide benefits including improvements in computing resource usage efficiency, security, and ease of use.

The disclosed technology can provide a variety of technical effects and benefits with respect to the efficiency of utilizing computing resource usage by increasing the accuracy associated with generating reports. By generating the reports at runtime and not saving the reports in memory the amount of storage space associated with reports can be reduced or eliminated. Instead of burdensome manual deletion of old reports, the disclosed technology can ensure that such reports are not stored against the user wishes.

As such, the disclosed technology may assist a user in more effectively generating a variety of reports by providing the specific benefits of performing runtime operations on organizational data stored in a multi-tenant environment. Further, any of the specific benefits provided to users can be used to improve the effectiveness of a wide variety of devices and services including any devices or services that rely on the disclosed technology. Accordingly, the improvements offered by the disclosed technology can result in tangible benefits to a variety of applications, devices, and/or systems including mechanical, electronic, and computing systems associated with the generation of reports.

With reference to the Figures, example embodiments of the present disclosure will be discussed in further detail.

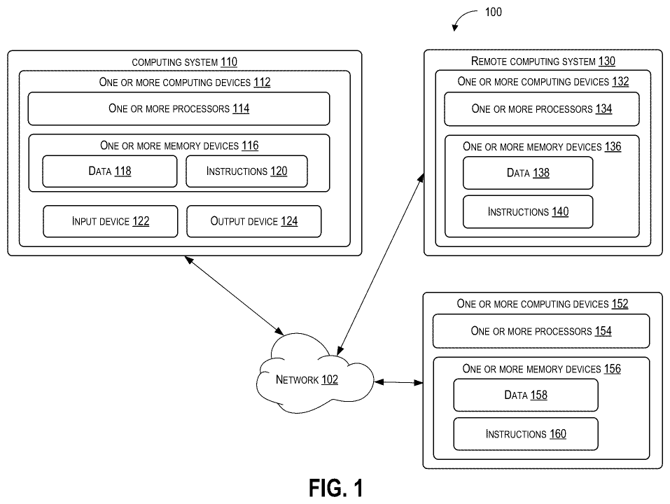

FIG. 1 depicts a block diagram of an example environment including a computing system that performs operations according to example embodiments of the present disclosure. The environment 100 includes a network 102, a computing system 110, one or more computing devices 112, one or more processors 114, one or more memory devices 116, data 118, instructions 120, a remote computing system 130, one or more computing devices 132, one or more processors 134, one or more memory devices 136, data 138, instructions 140, one or more computing devices 152, one or more processors 154, one or more memory devices 156, data 158, and instructions 160.

The network 102 can include any type of communications network. For example, the network 102 can include a local area network (LAN), a wide area network (WAN), an intranet, an extranet, and/or the Internet. Further, the network 102 can include any number of wired or wireless connections and/or links that can be used to communicate with one or more systems (e.g., the computing system 110 and/or the remote computing system 130) and/or one or more devices (e.g., the one or more computing devices 152). Communication over the network 102 can be performed via any type of wired and/or wireless connection and can use a wide variety of communication protocols (e.g., TCP/IP, HTTP, SMTP, FTP), encodings or formats (e.g., HTML, XML), and/or protection schemes (e.g., VPN, secure HTTP, SSL).

The computing system 110 can include any combination of systems and/or devices including one or more computing systems and/or one or more computing devices. Further, the computing system 110 may be connected (e.g., networked) to one or more computing systems and/or one or more computing devices via the network 102. The computing system 110 may operate in various different configurations including as a server or a client machine in client-server network environment, or as a peer machine in a peer-to-peer (or distributed) network environment. Though the computing system 110 is depicted in FIG. 1 as a single device, the computing system 110 can include any collection or combination of devices that individually or in combination with other devices, execute a set of one or more instructions to perform any one or more of the operations discussed herein.

In this example, the computing system 110 includes the one or more computing devices 112. The one or more computing devices 112 can include any type of computing device. For example, the one or more computing devices 112 can include a personal computing device (e.g., a desktop computing device), a mobile computing device (e.g., a smartphone or tablet), a wearable computing device (e.g., a smartwatch), an embedded computing device, a web appliance, a server, a network router, a switch, a bridge, or any device capable of executing a set of instructions (e.g., any combination of instructions which can include sequential instructions and/or parallel instructions) associated with one or more operations and/or one or more actions to be performed by the computing system 110 or any of the constituent components and/or devices of the computing system 110.

Any of the one or more computing devices 112 can include the one or more processors 114. The one or more processors 114 can be and/or include any processing device (e.g., a processor core, a microprocessor, an application-specific integrated circuit (ASIC), a field-programmable gate array (FPGA), a controller, or a microcontroller) and can include one processor or a plurality of processors that may be operatively connected. In some embodiments, the one or more processors 114 may include one or more complex instruction set computing (CISC) microprocessors, one or more reduced instruction set computing (RISC) microprocessors, one or more very long instruction word (VLIW) microprocessors, and/or one or more processors that are configured to implement other instruction sets.

The one or more computing devices 112 can include the one or more memory devices 116. The one or more memory devices 116 can be used to store data and/or information and can include one or more computer-readable media, one or more non-transitory computer-readable storage media, and/or one or more machine-readable media. Though the one or more memory devices 116 are depicted in FIG. 1 as a single unit (e.g., a single medium), the computer-readable storage media can include a single medium or multiple media (e.g., a centralized or distributed database, and/or associated caches and servers) that store one or more sets of instructions. Further, the computer-readable storage media can include any medium that is capable of storing, encoding, and/or carrying a set of instructions for execution by a computing device and which may cause the computing device to perform any of the one or more operations described herein. In some embodiments, the computer-readable storage media can include one or more solid-state memories, one or more optical media, and/or one or more magnetic media. By way of example, the one or more memory devices 116 can include any combination of random access memory (RAM), read only memory (ROM), erasable programmable read only memory (EPROM), electrically erasable programmable read only memory (EEPROM), one or more flash memory devices, one or more magnetic storage devices (e.g., one or more hard disk drives).

The one or more processors 114 can be configured to execute one or more instructions to perform the operations described herein including for example, one or more operations associated with validating organizational reports and generating validated reports. Further, the one or more memory devices 116 can store the data 118 and/or the instructions 120, which can be executed by the one or more processors 114 to cause the one or more computing devices 112 to perform one or more operations.

The data 118 can include organizational data (e.g., organizational data including information associated with an entity, request data including information associated with a request for one or more reports, and/or location-specific data including location-specific information as described herein). Further, the instructions 120 can include one or more instructions to use data including the data 118 to perform the one or more operations described herein. In some embodiments, the one or more memory devices 116 can be used to store one or more applications that can be operated by the one or more processors 114. The data 118, the instructions 120, and/or the one or more applications can be associated with an organization (e.g., a host entity, a client organization of a host entity, etc.). Further, the computing system 110 may be configured to manage the one or more applications. For example, the computing system 110 can perform one or more operations associated with accessing organizational data, request data, and/or location-specific data; and/or generating one or more reports associated with an entity.

Any of the one or more computing devices 112 can include one or more input devices 122 and/or one or more output devices 124. The one or more input devices 122 can be configured to receive input (e.g., user input) and can include one or more touch screens, one or more keyboards, one or more pointing devices, (e.g., mouse device), one or more buttons, one or more microphones, and/or one or more cameras. The one or more output devices 124 can include one or more display devices, one or more loudspeaker devices, one or more haptic output devices. By way of example, the one or more output devices 124 can be used to display a graphical user interface via a display device that can include a touch screen layer that is configured to detect one or more user inputs.

The remote computing system 130 includes the one or more computing devices 132. Each of the one or more computing devices 132 can include one or more processors 134, one or more memory devices 136, the data 138, and/or the instructions 140. The remote computing system 130 can include any of the attributes and/or capabilities of the computing system 110 and may be configured to perform any of the operations performed by the computing system 110. Further, the remote computing system 130 can communicate with one or more devices and/or one or more systems via the network 102.

In some embodiments, the remote computing system 130 can include one or more applications (e.g., computing software applications) that can be stored and/or executed by the remote computing system 130. Further, the one or more applications can include one or more applications that may be accessed from the computing system 110 and are at least partly operated from the remote computing system 130. Further, the data 138 can include one or more portions of the organizational data.

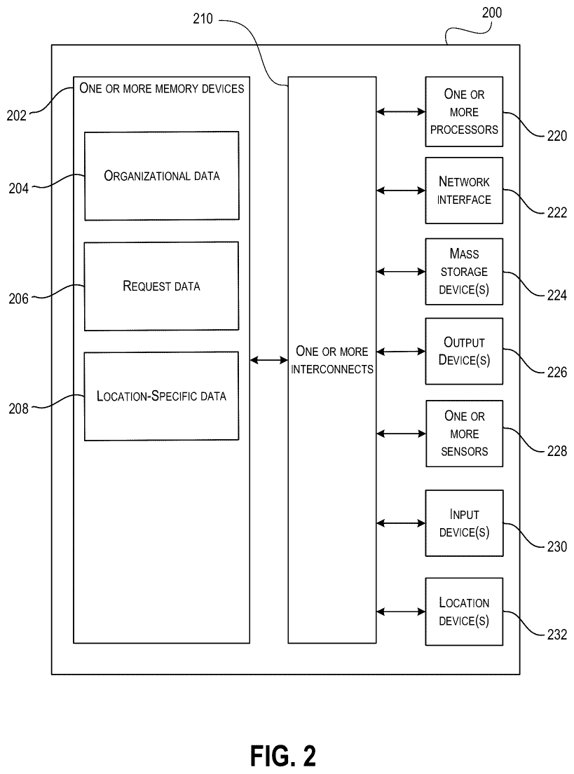

FIG. 2 depicts a block diagram of an example computing device according to example embodiments of the present disclosure. A computing device 200 can include one or more attributes and/or capabilities of the computing system 110, the remote computing system 130, the one or more computing devices 152, and/or the computing device 200. Furthermore, the computing device 200 can be configured to perform one or more operations and/or one or more actions that can be performed by the computing system 110, the remote computing system 130, the one or more computing devices 152, and/or the computing device 200.

As shown in FIG. 2, the computing device 200 can include one or more memory devices 202, organizational data 204, request data 206, location-specific data 208, one or more interconnects 210, one or more processors 220, a network interface 222, one or more mass storage devices 224, one or more output devices 226, one or more sensors 228, one or more input devices 230, and/or one or more location devices 232.

The one or more memory devices 202 can store information and/or data (e.g., the organizational data 204, the request data 206, and/or the location-specific data 208). Further, the one or more memory devices 202 can include one or more non-transitory computer-readable storage media, including RAM, ROM, EEPROM, EPROM, flash memory devices, magnetic disks, and combinations thereof. The information and/or data stored by the one or more memory devices 202 can be executed by the one or more processors 220 to cause the computing device 200 to perform operations including one or more operations associated with accessing request data, accessing organizational data, accessing location-specific data, and generating output including one or more reports based on runtime operations performed on the organizational data and the location-specific data.

The organizational data 204 can include one or more portions of data (e.g., the data 118, the data 138, and/or the data 158, which are depicted in FIG. 1) and/or instructions (e.g., the instructions 120, the instructions 140, and/or the instructions 160 which are depicted in FIG. 1) that are stored in the one or more memory devices 116, the one or more memory devices 136, and/or the one or more memory devices 156, respectively. Furthermore, the organizational data 204 can include information associated with a plurality of entities and regions associated with the entity. In some embodiments, the organizational data 204 can be received from one or more computing systems (e.g., the remote computing system 130 depicted in FIG. 1) which can include one or more computing systems that are remote (e.g., in another room, building, part of town, city, or nation) from the computing device 200.

The request data 206 can include one or more portions of data (e.g., the data 118, the data 138, and/or the data 158, which are depicted in FIG. 1) and/or instructions (e.g., the instructions 120, the instructions 140, and/or the instructions 160 which are depicted in FIG. 1) that are stored in the one or more memory devices 116, the one or more memory devices 136, and/or the one or more memory devices 156, respectively. In some embodiments, the request data 206 can be received from one or more computing systems (e.g., the remote computing system 130 depicted in FIG. 1) which can include one or more computing systems that are remote (e.g., in another room, building, part of town, city, or nation) from the computing device 200.

The location-specific data 208 can include one or more portions of data (e.g., the data 118, the data 138, and/or the data 158, which are depicted in FIG. 1) and/or instructions (e.g., the instructions 120, the instructions 140, and/or the instructions 160 which are depicted in FIG. 1) that are stored in the one or more memory devices 116, the one or more memory devices 136, and/or the one or more memory devices 156, respectively. Furthermore, the location-specific data 208 can include information associated with location-specific information for one or more regions (e.g., country, state, city, province, etc.) associated with the entity. In some embodiments, the location-specific data 208 can be received from one or more computing systems (e.g., the remote computing system 130 depicted in FIG. 1) which can include one or more computing systems that are remote (e.g., in another room, building, part of town, city, or nation) from the computing device 200.

The one or more interconnects 210 can include one or more interconnects or buses that can be used to send and/or receive one or more signals (e.g., electronic signals) and/or data (e.g., the organizational data 204, the request data 206, and/or the location-specific data 208) between components of the computing device 200, including the one or more memory devices 202, the one or more processors 220, the network interface 222, the one or more mass storage devices 224, the one or more output devices 226, the one or more sensors 228 (e.g., a sensor array), the one or more input devices 230, and/or the one or more location devices 232. The one or more interconnects 210 can be arranged or configured in different ways. For example, the one or more interconnects 210 can be configured as parallel or serial connections. Further the one or more interconnects 210 can include: one or more internal buses that are used to connect the internal components of the computing device 200; and one or more external buses used to connect the internal components of the computing device 200 to one or more external devices. By way of example, the one or more interconnects 210 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (Fire Wire), and/or other interfaces that can be used to connect components.

The one or more processors 220 can include one or more computer processors that are configured to execute the one or more instructions stored in the one or more memory devices 202. For example, the one or more processors 220 can, for example, include one or more general purpose central processing units (CPUs), application specific integrated circuits (ASICs), and/or one or more graphics processing units (GPUs). Further, the one or more processors 220 can perform one or more actions and/or operations including one or more actions and/or operations associated with the organizational data 204, the request data 206, and/or the location-specific data 208. The one or more processors 220 can include single or multiple core devices including a microprocessor, microcontroller, integrated circuit, and/or a logic device.

The network interface 222 can support network communications. The network interface 222 can support communication via networks including a local area network and/or a wide area network (e.g., the Internet). For example, the network interface 222 can allow the computing device 200 to communicate with the computing system 110 via the network 102.

The one or more mass storage devices 224 (e.g., a hard disk drive and/or a solid state drive) can be used to store data including the organizational data 204. The one or more output devices 226 can include one or more display devices (e.g., LCD display, OLED display, Mini-LED display, microLED display, plasma display, and/or CRT display), one or more light sources (e.g., LEDs), one or more loudspeakers, and/or one or more haptic output devices (e.g., one or more devices that are configured to generate vibratory output).

The one or more sensors 228 can be configured to detect various states and can include one or more cameras, one or more light detection and ranging (LiDAR) devices, one or more sonar devices, and/or one or more radar devices. Further, the one or more sensors 228 can be used to provide input (e.g., an image of a user captured using the one or more cameras) that can be used as part of a user interface that is used to access request data, access organizational data, access location-specific data, and generate output including one or more reports based on runtime operations performed on the organizational data and the location-specific data. For example, the one or more sensors 228 can be used to authenticate the identity of a user based on an image of the user's face that is captured using the one or more sensors 228.

The one or more input devices 230 can include one or more touch sensitive devices (e.g., a touch screen display), a mouse, a stylus, one or more keyboards, one or more buttons (e.g., ON/OFF buttons and/or YES/NO buttons), one or more microphones, and/or one or more cameras (e.g., cameras that are used to detect gestures that can trigger one or more operations by the computing device 200).

Although the one or more memory devices 202 and the one or more mass storage devices 224 are depicted separately in FIG. 2, the one or more memory devices 202 and the one or more mass storage devices 224 can be regions within the same memory module. The computing device 200 can include one or more additional processors, memory devices, network interfaces, which may be provided separately or on the same chip or board. The one or more memory devices 202 and the one or more mass storage devices 224 can include one or more computer-readable media, including, but not limited to, non-transitory computer-readable media, RAM, ROM, hard drives, flash drives, and/or other memory devices.

The one or more memory devices 202 can store sets of instructions for applications including an operating system that can be associated with various software applications or data. For example, the one or more memory devices 202 can store sets of instructions for one or more applications that are subject to one or more security policies that can be generated and/or implemented by the computing device 200 and/or one or more other computing devices or one or more computing systems. In some embodiments, the one or more memory devices 202 can be used to operate or execute a general-purpose operating system that operates on mobile computing devices and/or stationary devices, including for example, smartphones, laptop computing devices, tablet computing devices, and/or desktop computers.

The software applications that can be operated or executed by the computing device 200 can include applications associated with the computing system 110, the remote computing system 130, and/or the one or more computing devices 152 that are depicted in FIG. 1. Further, the software applications that can be operated and/or executed by the computing device 200 can include native applications, web services, and/or web-based applications.

The one or more location devices 232 can include one or more devices or circuitry for determining the position of the computing device 200. For example, the location device 232 can determine an actual and/or relative position of the computing device 200 by using a satellite navigation positioning system (e.g. a global positioning system (GPS), a Galileo positioning system, the GLObal Navigation satellite system (GLONASS), the BeiDou Satellite Navigation and Positioning system), an inertial navigation system, a dead reckoning system, based on an internet protocol (IP) address, by using triangulation and/or proximity to cellular towers or Wi-Fi hotspots, and/or beacons.

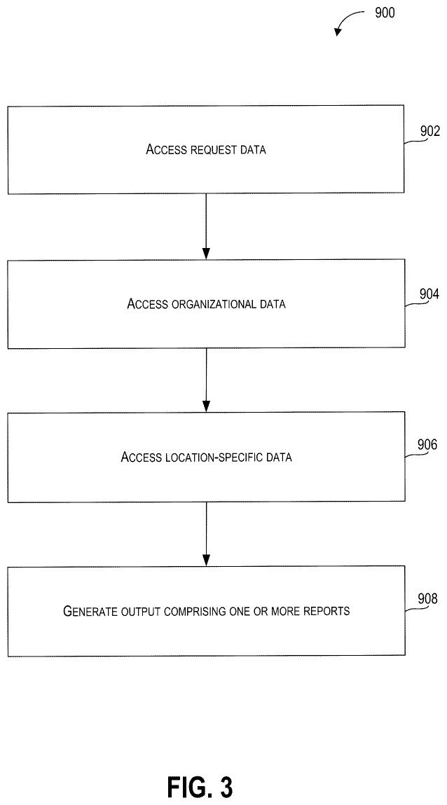

FIG. 3 depicts a flow diagram of generating reports at runtime according to example embodiments of the present disclosure. One or more portions of the method 900 can be executed and/or implemented on one or more computing devices or computing systems including, for example, the computing system 110, the remote computing system 130, the one or more computing devices 152, and/or the computing device 200. Further, one or more portions of the method 900 can be executed or implemented as an algorithm on the hardware devices or systems disclosed herein. FIG. 3 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 902, the method 900 can include accessing request data. At 904, the method 900 can include accessing, based at least in part on the request data, organizational data associated with the entity, wherein the organizational data comprises information associated with a plurality of entities and wherein the organizational data is stored in a multi-tenant environment in which a plurality of datasets of the organizational data are respectively associated with the plurality of entities.

At 906, the method 900 can include accessing, based at least in part on the request data, location-specific data comprising location-specific information for the one or more regions associated with the entity. At 908, the method 900 can include generating, based at least in part on one or more runtime operations performed on the location-specific data and the organizational data associated with the entity, output comprising one or more reports associated with the entity. For example, the computing system 110 can generate one or more reports that can be displayed on a display output device of the computing system 110 or another computing system and/or computing device that is configured to receive information and/or data from the computing system 110.

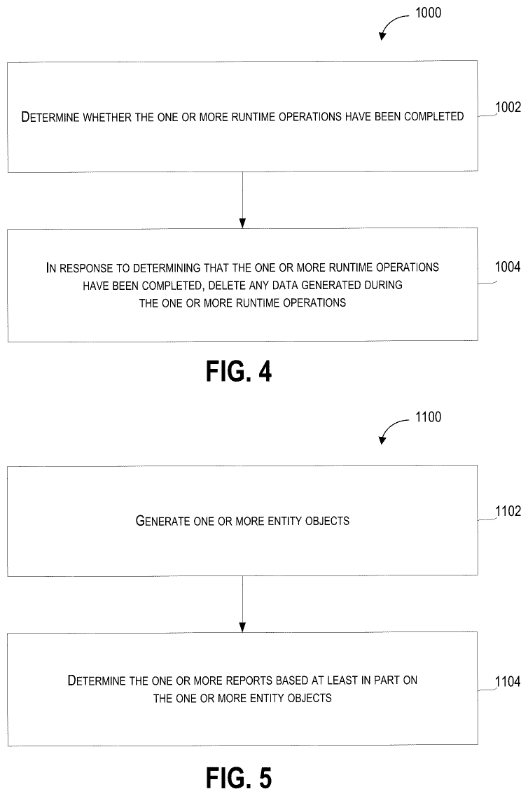

FIG. 4 depicts a flow diagram of generating reports at runtime according to example embodiments of the present disclosure. One or more portions of the method 1000 can be executed and/or implemented on one or more computing devices or computing systems including, for example, the computing system 110, the remote computing system 130, the one or more computing devices 152, and/or the computing device 200. Further, one or more portions of the method 1000 can be executed or implemented as an algorithm on the hardware devices or systems disclosed herein. FIG. 4 depicts steps performed in a particular order for purposes of illustration and discussion. In some embodiments, one or more portions of the method 1000 can be performed as part of the method 900 that is depicted in FIG. 3. Those of ordinary skill in the art, using the disclosures provided herein, will understand that various steps of any of the methods disclosed herein can be adapted, modified, rearranged, omitted, and/or expanded without deviating from the scope of the present disclosure.

At 1002, the method 1000 can include determining whether the one or more runtime operations have been completed. For example, the computing system 110 can determine whether each of the one or more runtime operations is still processing data (e.g., accessing data and/or performing operations on data).

At 1004, the method 1000 can include, in response to determining that the one or more runtime operations have been completed, deleting any data generated during the one or more runtime operations. For example, the computing system 110 can perform one or more operations associated with deleting data from volatile and non-volatile memory.

FIG. 5 depicts a flow diagram of generating reports at runtime according to example embodiments of the present disclosure. One or more portions of the method 1100 can be executed and/or implemented on one or more computing devices or computing systems including, for example, the computing system 110, the remote computing system 130, the one or more computing devices 152, and/or the computing device 200. Further, one or more portions of the method 1100 can be executed or implemented as an algorithm on the hardware devices or systems disclosed herein. FIG. 5 depicts steps performed in a particular order for purposes of illustration and discussion. In some embodiments, one or more portions of the method 1100 can be performed as part of the method 900 that is depicted in FIG. 3. Those of ordinary skill in the art, using the disclosures provided herein, will understand that various steps of any of the methods disclosed herein can be adapted, modified, rearranged, omitted, and/or expanded without deviating from the scope of the present disclosure.

At 1102, the method 1100 can include generating at runtime, based at least in part on the organizational data and the location-specific data, one or more entity objects at runtime. The one or more entity objects can be respectively associated with the one or more regions. For example, if the entity does business in a federal region and two state regions of the federal region the computing system 110 could generate three entity objects including one entity object for the federal region and two entity objects for the state regions.

At 1104, the method 1100 can include determining the one or more reports based at least in part on the one or more entity objects. For example, the computing system 110 can use the data from the entity objects to generate the one or more reports. For example, the one or more entity objects can include the amount of benefits paid to one or more employees of the entity.

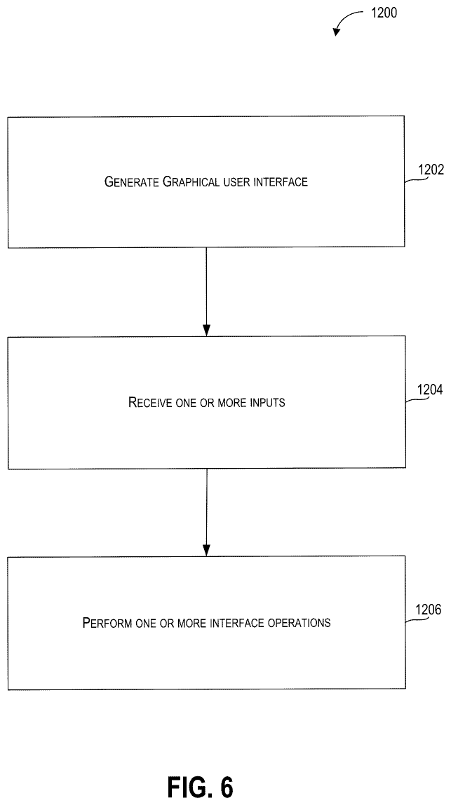

FIG. 6 depicts a flow diagram of generating reports at runtime according to example embodiments of the present disclosure. One or more portions of the method 1200 can be executed and/or implemented on one or more computing devices or computing systems including, for example, the computing system 110, the remote computing system 130, the one or more computing devices 152, and/or the computing device 200. Further, one or more portions of the method 1200 can be executed or implemented as an algorithm on the hardware devices or systems disclosed herein. FIG. 6 depicts steps performed in a particular order for purposes of illustration and discussion. In some embodiments, one or more portions of the method 1200 can be performed as part of the method 900 that is depicted in FIG. 3. Those of ordinary skill in the art, using the disclosures provided herein, will understand that various steps of any of the methods disclosed herein can be adapted, modified, rearranged, omitted, and/or expanded without deviating from the scope of the present disclosure.

At 1202, the method 1200 can include generating a graphical user interface. The graphical user interface can include one or more interface elements associated with one or more reports. Further, the one or more interface elements can be configured to receive one or more inputs. For example, the computing system 110 can generate a graphical user interface on a display output device (e.g., a touchscreen display device) that shows a representation of the one or more reports and includes interface elements that the user can use to add notes to the one or more reports.

At 1204, the method 1200 can include receiving the one or more inputs. For example, the computing system 110 can include a touch screen display that can display the one or more entries. The user can touch the portion of the touch screen display that includes the one or more reports and can then use an on-screen keyboard to navigate the one or more reports.

At 1206, the method 1200 can include performing, based at least in part on the one or more inputs, one or more interface operations on the one or more reports. For example, the computing system 110 can use the input provided by the user and modify an existing entry of a report with the entry specified by the one or more inputs provided by the user.

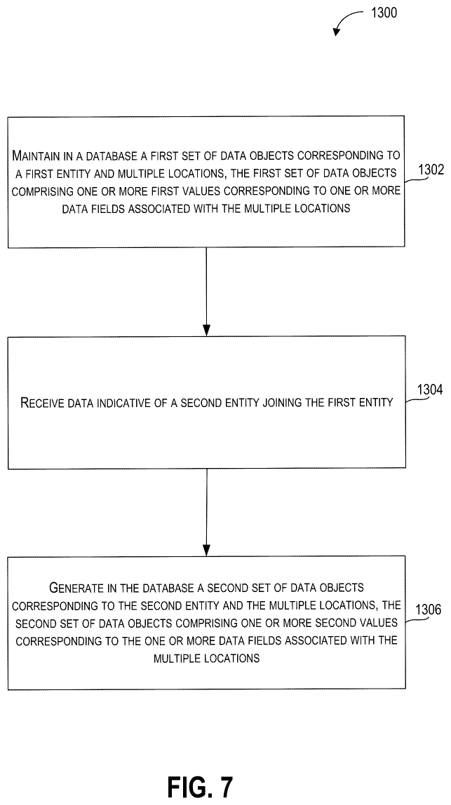

FIG. 7 depicts a flow diagram of generating reports at runtime according to example embodiments of the present disclosure. One or more portions of the method 1300 can be executed and/or implemented on one or more computing devices or computing systems including, for example, the computing system 110, the remote computing system 130, the one or more computing devices 152, and/or the computing device 200. Further, one or more portions of the method 1300 can be executed or implemented as an algorithm on the hardware devices or systems disclosed herein. FIG. 7 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1302, the method 1300 can include maintaining in a database a first set of data objects corresponding to a first entity and multiple locations, the first set of data objects comprising one or more first values corresponding to one or more data fields associated with the multiple locations. For example, the computing system 110 can maintain in a centralized database (e.g., a multi-tenant database, the one or more memory devices 116) a first set of data objects (e.g., in the form of a first data model and/or graph) corresponding to a host entity and multiple locations, where the first set of data objects includes one or more first values corresponding to one or more data fields (e.g., the entity or host state data 612) associated with the multiple locations.

At 1304, the method 1300 can include receiving data indicative of a second entity joining the first entity. For example, the computing system can receive (e.g., via a graphical user interface of the computing system and/or the one or more input devices 122) data indicating that an organization (e.g., a company) has become a member and/or a client organization of the host entity.

At 1306, the method 1300 can include generating in the database a second set of data objects corresponding to the second entity and the multiple locations, the second set of data objects comprising one or more second values corresponding to the one or more data fields associated with the multiple locations. For example, the computing system 110 can generate in the centralized database (e.g., a multi-tenant database, the one or more memory devices 116) a second set of data objects (e.g., in the form of a second data model and/or graph) corresponding to the organization and the multiple locations (e.g., the IRS, Alaska, New York, etc.), where the second set of data objects includes one or more second values corresponding to the one or more data fields (e.g., the entity or host state data 612) associated with the multiple locations.

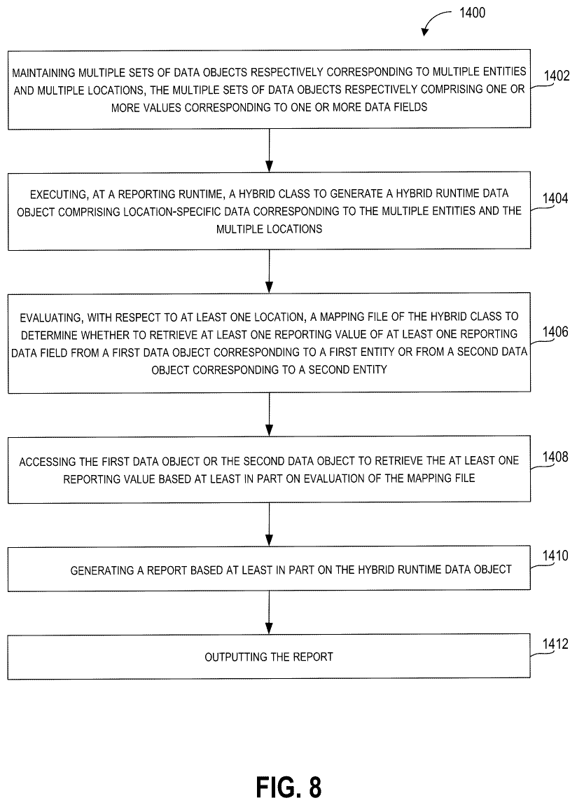

FIG. 8 depicts a flow diagram of generating reports at runtime according to example embodiments of the present disclosure. One or more portions of the method 1400 can be executed and/or implemented on one or more computing devices or computing systems including, for example, the computing system 110, the remote computing system 130, the one or more computing devices 152, and/or the computing device 200. Further, one or more portions of the method 1400 can be executed or implemented as an algorithm on the hardware devices or systems disclosed herein. FIG. 8 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1402, the method 1400 can include maintaining (e.g., by the computing system 110, in a multi-tenant database and/or the one or more memory devices 116) multiple sets of data objects (e.g., in the form of multiple data models and/or graphs) respectively corresponding to multiple entities (e.g., a host entity, a client organization of the host entity, etc.) and multiple locations (e.g., locations such as, for instance, the IRS, Alaska, New York, etc.), the multiple sets of data objects respectively comprising one or more values corresponding to one or more data fields (e.g., the entity or host state data 612).

At 1404, the method 1400 can include executing (e.g., by the computing system 110), at a reporting runtime, a hybrid class to generate a hybrid runtime data object comprising location-specific data corresponding to the multiple entities and the multiple locations.

At 1406, the method 1400 can include evaluating (e.g., by the computing system 110), with respect to at least one location (e.g., Alaska), a mapping file (e.g., an index, a list, a configuration file, a look-up table, etc.) of the hybrid class to determine whether to retrieve at least one reporting value of at least one reporting data field (e.g., the entity or host state data 612) from a first data object (e.g., a first data model and/or graph) corresponding to a first entity (e.g., a host entity) or from a second data object (e.g., a second data model and/or graph) corresponding to a second entity (e.g., a client organization of a host entity).

At 1408, the method 1400 can include accessing (e.g., by the computing system 110) the first data object or the second data object to retrieve the at least one reporting value based at least in part on evaluation of the mapping file.

At 1410, the method 1400 can include generating (e.g., by the computing system 110) a report based at least in part on the hybrid runtime data object (e.g., based at least in part on execution of the hybrid class to generate the hybrid runtime data object and evaluation of the mapping file to determine from which data object to retrieve the at least one reporting value).

At 1412, the method 1400 can include outputting the report (e.g., by the computing system 110 via a user graphical interface (GUI) and/or a display of the computing system such as, for instance, the one or more output devices 124).

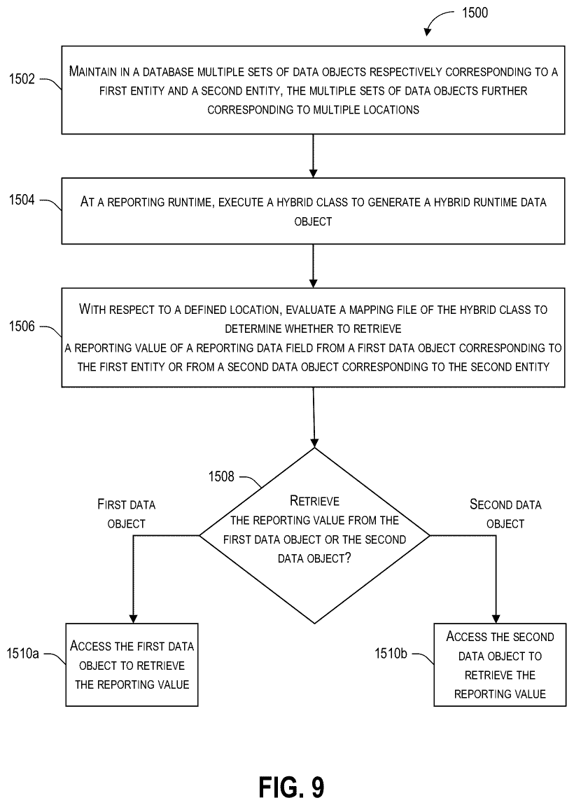

FIG. 9 depicts a flow diagram of generating reports at runtime according to example embodiments of the present disclosure. One or more portions of the method 1500 can be executed and/or implemented on one or more computing devices or computing systems including, for example, the computing system 110, the remote computing system 130, the one or more computing devices 152, and/or the computing device 200. Further, one or more portions of the method 1500 can be executed or implemented as an algorithm on the hardware devices or systems disclosed herein. FIG. 9 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1502, the method 1500 can include maintaining (e.g., by the computing system 110) in a database (e.g., a multi-tenant database and/or the one or more memory devices 116) multiple sets of data objects (e.g., in the form of multiple data models and/or graphs) respectively corresponding to a first entity (e.g., a host entity) and a second entity (e.g., a client organization of a host entity), the multiple sets of data objects further corresponding to multiple locations (e.g., locations such as, for instance, the IRS, Alaska, New York, etc.).

At 1504, the method 1500 can include, at a reporting runtime, executing (e.g., by the computing system 110) a hybrid class to generate a hybrid runtime data object (e.g., a hybrid runtime data object comprising location-specific data corresponding to the first entity, the second entity, and/or the multiple locations).

At 1506, the method 1500 can include, with respect to a defined location (e.g., Alaska), evaluate (e.g., by the computing system 110) a mapping file (e.g., an index, a list, a configuration file, a look-up table, etc.) of the hybrid class to determine whether to retrieve a reporting value of a reporting data field (e.g., the entity or host state data 612) from a first data object (e.g., a first data model and/or graph) corresponding to the first entity or from a second data object (e.g., a second data model and/or graph) corresponding to the second entity.

At 1508, the method 1500 can include determining (e.g., by the computing system 110) whether to retrieve the reporting value from the first data object or the second data object.

If it is determined at 1508 to retrieve the reporting value from the first data object, then at 1510a, the method 1500 can include accessing (e.g., by the computing system 110) the first data object to retrieve the reporting value.

If it is determined at 1508 to retrieve the reporting value from the second data object, then at 1510b, the method 1500 can include accessing (e.g., by the computing system 110) the second data object to retrieve the reporting value.

Although not illustrated in the example embodiment depicted in FIG. 9, in some embodiments, method 1500 can further include generating (e.g., by the computing system 110) a report based at least in part on the hybrid runtime data object and/or the reporting value (e.g., based at least in part on execution of the hybrid class to generate the hybrid runtime data object, evaluation of the mapping file to determine from which data object to retrieve the reporting value, and retrieval of the reporting value). In these embodiments, although not illustrated in the example embodiment depicted in FIG. 9, method 1500 can further include outputting the report (e.g., by the computing system 110 via a user graphical interface (GUI) and/or a display of the computing system such as, for instance, the one or more output devices 124).

Numerous details are set forth in the foregoing description. However, it will be apparent to one of ordinary skill in the art having the benefit of this disclosure that the present disclosure may be practiced without these specific details. In some instances, structures and devices are shown in block diagram form, rather than in detail, to avoid obscuring the present disclosure.

Some portions of the detailed description have been presented in terms of processes and symbolic representations of operations on data bits within a computer memory. Here, a process can include a self-consistent sequence of steps leading to a result. The steps can include those requiring physical manipulations of physical quantities. These quantities can take the form of electrical or magnetic signals capable of being stored, transferred, combined, compared, and otherwise manipulated. These signals can be referred to as bits, values, elements, symbols, characters, terms, numbers, or the like.

These terms and similar terms can be associated with physical quantities and can represent labels applied to these quantities. The terms including “analyzing,” “determining,” “identifying,” “adjusting,” “transmitting,” “receiving,” “processing” “generating,” or the like, can refer to the actions and processes of a computer system, a computing device, or similar electronic computing device, that manipulates and transforms data represented as physical (e.g., electronic) quantities within the computer system's registers and memories into other data that can be similarly represented as physical quantities within the computer system's memories, registers, or other information storage device, data transmission device, or data processing device.

Certain examples of the present disclosure can relate to an apparatus for performing the operations described herein. This apparatus may include a computing device that is activated or reconfigured by a computer program comprising electronic instructions stored in the computing device. Such a computer program may be stored in a computer readable storage medium, which can include any type of storage. For example, the storage can include hard disk drives, solid state drives, floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The above description is intended to be illustrative, and not restrictive. The scope of the disclosure can therefore be determined with reference to the appended claims.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A data management system that performs runtime generation of multi-entity reports from a multi-tenant database without intermingling of data, the data management system comprising:
one or more processors;
the multi-tenant database that stores a plurality of datasets that are respectively associated with a plurality of different database client entities associated with a database host entity, and wherein the multi-tenant database stores the plurality of datasets separately from one another; and
one or more non-transitory computer-readable media that store instructions that, when executed by the one or more processors, cause the data management system to perform operations, the operations comprising:
receiving request data comprising a request for one or more reports associated with two or more of the database client entities;
accessing, based at least in part on the request data, data associated with the plurality of database client entities, wherein the data is stored in the multi-tenant database in which the plurality of datasets respectively associated with the plurality of database client entities are stored separately from one another;
merging into a temporary reporting dataset, during one or more runtime operations, at least a portion of each of two or more of the plurality of datasets that are respectively associated with the two or more the plurality of database client entities;
generating, during the one or more runtime operations, the one or more reports associated with the two or more of the database client entities based on the temporary reporting dataset; and
providing the one or more reports as an output.

2. The data management system of claim 1, wherein the operations comprise:
obtaining, based at least in part on the request data, location-specific data comprising location-specific information for one or more regions associated with the one or more reports and the database host entity; and
selecting certain portions of the two or more of the plurality of datasets of the data for inclusion in the temporary reporting dataset based at least in part on the location-specific information for the one or more regions.

3. The data management system of claim 2, wherein the location-specific data comprises data indicating, for each of the regions, whether the region is a client region or a host region.

4. The data management system of claim 3, wherein the location-specific data is stored in a mapping file evaluated by a hybrid class.

5. The data management system of claim 1, wherein the operations comprise:
subsequent to generating the one or more reports, deleting the temporary reporting dataset.

6. The data management system of claim 1, wherein the temporary reporting dataset is exclusively stored on one or more volatile memory devices.

7. The data management system of claim 1, wherein the one or more runtime operations are performed iteratively over one or more iterations, and wherein the one or more runtime operations comprise validating the one or more reports after each of the one or more iterations.

8. The data management system of claim 1, wherein the one or more runtime operations are only performed after the request data is accessed and before the output is generated.

9. The data management system of claim 1, wherein:
merging, during one or more runtime operations, at least the portion of each of the two or more of the plurality of datasets comprises generating during the one or more runtime operations, one or more new entity data objects; and
generating, during the one or more runtime operations, the one or more reports comprises determining the one or more reports based at least in part on the one or more new entity data objects.

10. The data management system of claim 1, wherein the plurality of different datasets comprise a plurality of different data models.

11. The data management system of claim 1, wherein the plurality of different datasets comprise a plurality of different data graphs.

12. The data management system of claim 1, wherein each of the plurality of different datasets comprises a plurality of data objects.

13. The data management system of claim 1, wherein the operations comprise:
generating a graphical user interface comprising one or more interface elements associated with the one or more reports, wherein the one or more interface elements are configured to receive one or more inputs;
receiving the one or more inputs; and
performing, based at least in part on the one or more inputs, one or more interface operations on the one or more reports;
wherein the one or more interface operations comprise deleting a report, modifying a report, or sending a report to one or more remote computing devices.

14. The data management system of claim 1, wherein merging, during the one or more runtime operations, at least the portion of each of two or more of the plurality of datasets into the temporary reporting dataset comprises selecting the portions of the two or more of the plurality of datasets for inclusion in the temporary reporting dataset based at least in part on a mid-period attribute that indicates a mid-period association date for one of the database client entities with respect to the database host entity.

15. A computer-implemented method of generating reports at runtime, the computer-implemented method comprising:
accessing, by a data management system comprising one or more processors, request data comprising a request for one or more reports associated with a database host entity;
accessing, by the data management system, based at least in part on the request data, a plurality of datasets respectively associated with a plurality of database client entities of the database host entity, wherein the plurality of datasets are stored in a multi-tenant database in which the plurality of datasets are stored separately from one another;
accessing, by the data management system, based at least in part on the request data, location-specific data comprising location-specific information for one or more regions associated with the host entity; and
generating, by the data management system, based at least in part on one or more runtime operations performed on the location-specific data and the data associated with the database client entities, the one or more reports associated with the database host entity.

16. The computer-implemented method of claim 15, wherein generating the one or more reports comprises temporarily merging at least a portion of each of two or more of the plurality of datasets respectively associated with the plurality of database client entities into a temporary reporting dataset.

17. The computer-implemented method of claim 15, wherein the plurality of database client entities are respectively associated with a plurality of shards of the data.

18. One or more tangible non-transitory computer-readable media storing computer-readable instructions that when executed by one or more processors cause the one or more processors to perform operations, the operations comprising:
receiving request data comprising a request for one or more reports associated with a database host entity;
accessing, based at least in part on the request data, data associated with the database host entity, wherein the data comprises information associated with a plurality of database client entities of the database host entity and one or more regions associated with the entity, and wherein the data is stored in a multi-tenant database in which a plurality of datasets of the data that are respectively associated with the plurality of database client entities are stored separately from one another;
obtaining, based at least in part on the request data, location-specific data comprising location-specific information for the one or more regions associated with the entity; and
generating, based at least in part on one or more runtime operations performed on the location-specific data and the data associated with the entity, output comprising the one or more reports associated with the database host entity.

19. The one or more tangible non-transitory computer-readable media of claim 18, wherein the one or more runtime operations are performed without modifying the data or the location-specific data.

20. The one or more tangible non-transitory computer-readable media of claim 19, wherein the plurality of datasets are encrypted and configured to be encrypted or decrypted using one of a plurality of encryption keys respectively associated with the plurality of database client entities.
